(19) United States
(12) Patent Application Publication
(10) Pub. No.: US 2025/0326690 A1
(43) Pub. Date: Oct. 23, 2025

(54) Non-Weathering, Flame-Proof Composite Material

(71) Applicant: Leibniz-Institut für Neue Materialien gemeinnützige GmbH, Saarbrücken (DE)

(72) Inventors: Bernd Reinhard, Merzig (DE); Carsten Becker-Willinger, Saarbrücken (DE); Mirko Bukowski, St. Ingbert (DE); Aibate Hatago Stuurmann, Windhoek (NA); Leonoritha Roswitha Naomas, Windhoek (NA); Ahmad Cheikhyoussef, Windhoek (NA); Erold Naomab, Windhoek (NA)

(21) Appl. No.: 18/868,213

(22) PCT Filed: May 25, 2023
(86) PCT No.: PCT/EP2023/064033

§ 371 Date: Nov. 22, 2024

(30) Foreign Application Priority Data
May 27, 2022 (DE) 10 2022 113 440.7

(51) Int. Cl. C04B 28/00; C04B 14/06; C04B 18/26; C04B 26/28; C04B 103/63; C04B 111/40

(52) U.S. Cl. CPC C04B 28/008; C04B 14/06; C04B 18/265; C04B 26/28; C04B 2103/63; C04B 2111/40

(57) ABSTRACT

A method for producing a composite material includes using an alkaline binder containing alkali silicate glass; an organic gelling agent and SiO₂ particles; and a biological carrier material. The composite material is particularly stable, flame-proof and also suitable for the exterior.

### FIELD OF THE INVENTION

The invention relates to a process for producing a composite material and to a composite material produced and to the use thereof.

### PRIOR ART

Wood particleboards are composite materials that are produced from wood turnings and a binder under pressure and heat. There are many variations, especially with regard to wood turning characteristics, wood turning orientation and numerous production methods by means of different binder systems, by means of which wood particleboards can be produced as compact materials for a wide range of applications and for a wide range of products. These involve using essentially organic binders based on phenolic resins and aminoplast resins, and more recently also those based on polyurethane resins. A disadvantage here is that the resins mentioned can release formaldehyde, which is harmful to health, during the use of the particleboards, and that both the wood turnings and the binders are combustible because they are organic in nature. In order to enable use of such composite materials, for example in the construction sector, inorganic additions are introduced, which create a flame-retardant effect. These especially include, for example, borates and phosphates, but also tannins, which, in the event of fire, react to form more highly condensed products which in turn shield the surface of the component from further ingress of oxygen. Additional oxygen barrier action is achieved, for example, by introduction of laminar silicatic fillers, for example vermiculite. In the case of particularly demanding fire protection requirements, however, the flame retardancy achievable with such composite materials is insufficient to satisfy the corresponding standards. The use of foamable matrices with thermally insulating foam structures in the event of fire (intumescent masses) using hydroxymethylcellulose, combinations of dicyandiamide and boric acid, and ammonium phosphate-containing layers does not bring any satisfactory improvement in the situation either. In addition, the release of formaldehyde in particular from the matrix material, in spite of all efforts to improve fire protection in these material approaches, still remains an unsolved problem.

In addition, inorganic, noncombustible binders are employed in industry. However, binders based on MgCl₂/MgO/polyethyleneimine or else comprising gypsum lead to boards of low mechanical strength. Other inorganic binder phases in particle-or fiber-containing boards are cements, but these also have high weight and cannot be processed directly by material removal. In addition, cements as binders have a very poor carbon footprint since, in the course of the production process, CO₂ is released both in the generation of the furnace temperature (1400° C.) and as a result of thermal elimination of CO₂ from the CaCO₃ precursor.

It is frequently the case that water repellents, fungicides or insecticides are also still used in order to make the boards resistant to weathering and further natural influences. For example, stilbenes, quinones or pyran derivatives are used to improve termite resistance, or thallium chloride, fluorosilicic acid, potassium arsenite as contact insecticides to counter Hylotrupes larvae.

Waterglass-based binders would be an alternative with regard to the achievable flame retardancy in combination with weight saving and a better carbon footprint, but have not gained any significance to date for wood particleboards because of their lack of hydrolysis stability and high brittleness.

According to DIN EN 312, particleboards are classified into various categories (P1: particleboards for general purposes; P2: particleboards for interior fitout, including furniture for use in dry areas; P3: particleboards for non-load-bearing purposes in wet areas; P4: particleboards for load-bearing purposes in dry areas; P5: particleboards for load-bearing purposes in wet areas; P6: highly durable particleboards for load-bearing purposes in dry areas; P7: highly durable particleboards for load-bearing purposes in wet areas).

In order generally to improve the flexibility and ease of handling of waterglasses, these used to be admixed, for example, with hydrogel-forming organic polymers (e.g. galactomannans).

Halliburton [U.S. Pat. No. 3,390,723] discloses a binder composed of sodium waterglass and galactomannan which is used as an auxiliary for in situ establishment of diversions for liquid streams in rock formations. There is no description of use for wood particleboards.

Industrieverband Brandschutz [DE3439929A1] describes a transparent fire protection composition for the production of fire protection components and for the coating of components and parts of built structures made from sodium waterglass, an organic binder (for example galactomannan), which has a firm consistency. For this purpose, the waterglass is admixed with a gel-forming acid (e.g. citric acid, B(OH)₃, H₃PO₄) and water to form a hydrogel, and additionally a preservative (Cu(II) salt) and solidified with the organic binder to form the transparent solid-state fire protection composition. The gel-forming acid leads to acceleration of the reaction that does contribute to transparency of the claimed reaction product but would be unsuitable for the production of wood particleboards.

Seamans [U.S. Pat. No. 4,212,920A] describes a flame retardant composition composed of sodium waterglass, gum arabic and epoxy resin or latex, from which a product in board form can be produced via the press molding method in combination with cellulose fibers. The proportional addition of up to 20% epoxy resin or latex serves to improve the moisture resistance of the binder composition.

Application [WO2015010690A2] describes a flexible fire protection composition containing inorganic gel formers and hydrogel-forming biomacromolecules (=galactomannans). The use of the galactomannans serves to achieve dimensional stability and the possibility of transportation via the formation of an organic framework structure that has a stabilizing effect on the inorganic gel formers. The fire protection composition is processed via casting, rolling or calendering and finds use as an interlayer between two glass panes. No particular moisture resistance of the composition is required here since the glass panes are sealed at the edge. Because of the lack of moisture resistance, the composition described cannot viably be used as a binder for the creation of wood particleboards for use in the construction sector since the resulting workpieces would not be stable to weathering.

There is also a need for weathering-resistant, fire-resistant, formaldehyde-free composite materials, especially wood particleboards, that can be obtained at least partly from local resources and have a low CO2 footprint. In addition, the composite materials should also be resistant to insects such as termites.

Moreover, production should also be possible by simple means.

### Object

It is an object of the invention to provide a process for producing a weathering-resistant, preferably fire-resistant, composite material, and also the composite material and the use thereof.

### Achievement of Object

This object is achieved by the inventions having the features of the independent claims. Advantageous developments of the inventions are characterized in the dependent claims. The wording of all claims is hereby incorporated by reference into this description. The inventions also encompass all viable and especially all mentioned combinations of independent and/or dependent claims.

The object is achieved by a process for producing a composite material, comprising the following steps:
a) providing an alkaline composition comprising at least one alkali metal silicate waterglass, at least one organic gel former;
b) adding at least one type of SiO₂ particles;
c) combining the composition with at least one biological carrier material, such as fibers, turnings or mats from biological sources;
d) compacting the resultant composite under pressure and elevated temperature in a mold;

e) after demolding, drying the composite to obtain the composite material.

There follows a description in detail of individual process steps. The steps need not necessarily be conducted in the sequence specified, and the process to be outlined may also include further, unspecified steps.

An alkaline composition comprising at least one alkali metal silicate waterglass and at least one organic gel former is provided.

The alkali metal silicate waterglass is preferably a sodium, potassium and/or lithium silicate waterglass, more preferably a sodium and/or potassium silicate waterglass, more preferably a potassium silicate waterglass.

The waterglass is preferably a waterglass of high concentration, high viscosity and high solids content.

Preference is given to a waterglass having a solids content of more than 40% by weight, preferably 40% by weight to 70% by weight, especially 40% by weight to 60% by weight.

A further feature of waterglass is the molar ratio of SiO₂ and alkali metal oxide (M₂O) in the waterglass. This molar SiO₂: M₂O ratio is referred to as modulus. The waterglass preferably has a molar SiO₂/M₂O ratio (modulus) of 0.8 to 4. The waterglass is dissolved in the composition. The waterglass used is preferably a liquid waterglass.

If necessary, preferably only water is added to the composition as solvent.

The composition is an alkaline composition. The pH thereof is preferably above 12, especially above 13.

The composition preferably comprises at least one alkali metal hydroxide, preferably LiOH, KOH and/or NaOH, preferably KOH and/or NaOH, more preferably KOH. The alkali metal hydroxide and the alkali metal silicate waterglass preferably have the same alkali metal, for example a potassium silicate waterglass and KOH. The alkali metal hydroxide activates the SiO₂ particles, especially the ground sand.

The composition also comprises at least one organic gel former. The organic gel former is preferably a polysaccharide which may also have been chemically modified.

Suitable polysaccharides are preferably base-stable.

The organic gel former is preferably selected from xanthan, gum arabic, guaran, galactomannans or mixtures thereof, where the gel former may have been chemically modified. Preference is given to galactomannans. The ratio between galactose and mannose may be 1:1 to 1:5, preferably 1:2.

Examples of chemical modifications are hydroxyethyl, hydroxypropyl, carboxyl, carboxyalkyl ether groups (e.g. carboxymethyl ethers), and combinations of different chemical modifications in one polysaccharide.

In a preferred embodiment of the invention, the alkali metal waterglass and the alkali metal hydroxide are first added together before the organic gel former is added.

Water is preferably used as solvent in the composition. This can be added in order to adjust the solids content and/or viscosity of the composition, or is defined by the waterglass solution, such that no additional solvent is added.

The composition is preferably stirred for at least 3 hours, preferably at least 10 hours, more preferably at least 20 hours. Preference is given to 3 to 96 hours, particular preference to 10 to 96 hours, especially 20 to 48 hours.

In a preferred embodiment, stirring is effected at a temperature between 10 and 40° C., especially 15 to 25° C. This is preferably the ambient temperature.

Preference is given to stirring in a closed vessel.

The resultant composition (precursor composition) is storable and can be stored until further processing. During the storage, there may be swelling of the gel former. But the composition remains activatable and suitable for processing. The composition is preferably storable for at least 6 months, especially at least 1 year.

At least one type of SiO₂ particles is added to the composition. These are preferably SiO₂ particles comprising particles in the micrometer range as the main constituent. Preference is given to SiO₂ particles having an average particle size of 0.05 μm to 70 μm, preferably 0.2 μm to 30 μm.

Preference is given to particles having a particle distribution with d₉₀ below 30 μm. The particles preferably have a particle distribution with doo below 30 μm and d₁₀ below 6 μm. Particular preference is given to particles having a particle distribution with d₉₀ between 2 μm and 30 μm and d₁₀ between 0.1 and 6 μm, especially particles having a particle distribution with d₉₀ between 10 μm and 30 μm and d₁₀ between 0.2 and 2 μm. More preferably particles having a d₉₀ between 2μm and 30 μm, d₅₀ between 1 and 8 μm and d₁₀ between 0.1 and 6 μm, preferably having a particle distribution with d₉₀ between 10 μm and 30 μm, d₅₀ between 2 and 5 μm and d₁₀ between 0.2 and 2 μm.

The distributions are determined as powder and as aqueous dispersion by laser diffraction; preference is given to determination in aqueous dispersion.

In a preferred embodiment of the invention, the particles comprise ground sand and preferably are ground sand that has preferably been ground to the above particle distribution.

The specific surface area of the particles is preferably 1 to 5 m²/g, especially 1.5 to 3.5 m²/g (determined by BET).

The SiO₂ content is preferably above 90% by weight, especially above 95% by weight, very particularly above 99% by weight (ascertained via ICP-OES (after microwave digestion, Horiba Jobin Yvon Ultima2, digestion in 1 ml of 65% HNO₃, 3 ml of 35% HCl, 1 ml of 50% HF and 2 ml of ultrapure water. The hydrolyzate is analyzed in terms of its mineral content by ICP-OES. Quantitative detection is effected by means of standard calibration curves)).

The resultant composition is preferably homogenized with stirring.

In one embodiment of the invention, fumed silica is added alternatively or additionally to the above-described particles. This may have a smaller particle distribution. For instance, the fumed silica may comprise particles having a size below 1 μm. One example of fumed silica is, for example, an Aerosil having a particle diameter of 200-300 nm. The fumed silica can shorten the drying time until achievement of complete water stability. However, the pot life of the activated composition is usually also reduced.

It is also possible, but not preferable, to add further inorganic substances, for example up to 10% by weight. Preference is given to inorganic substances having a proportion of SiO₂ of more than 50% by weight. Examples of these would be quartz, sheet silicates such as mica, wollastonite. Further examples are shown in table 1.

The resultant activated composition is preferably processed to a paste. The viscosity can be adjusted in accordance with the desired processing by adding of solvent.

The composition preferably has a pot life of up to 48 hours. The pot life can especially be adjusted via the size distribution of the SiO₂ particles. At below 10° C. or in the case of storage in a closed vessel, the pot life may be extended to up to 8 days.

In a preferred embodiment, the weight ratio between alkali metal waterglass and SiO₂ particles is 30:70 to 70:30, preferably 40:60 to 60:40.

In a preferred embodiment of the invention, the activated composition comprises 35% to 60% by weight of alkali metal waterglass, 1.5% to 5% by weight of at least one alkali metal hydroxide, 0.3% to 2.5% by weight of at least one gel former, 30% to 60% by weight of at least one type of SiO₂ particles. In a particularly preferred embodiment of the invention, the activated composition comprises 40% to 55% by weight of alkali metal waterglass, 1.5% to 5% by weight of at least one alkali metal hydroxide, 0.3% to 1.1% by weight of at least one gel former, 30% to 55% by weight of at least one type of SiO₂ particles.

One example of a composition would be, for example, 49.3% by weight of alkali metal waterglass, 4% by weight of at least one alkali metal hydroxide, 0.8% by weight of gel former and 45.9% by weight of ground sand.

The percentages by weight are preferably based on the weight of the alkali metal hydroxide. It is preferably alkali metal hydroxide with at least a proportion of 75% by weight of alkali metal hydroxide, especially at least 80% by weight, most preferably at least 85% by weight, based on the weight.

For example, potassium hydroxide is typically available in solid form with a KOH content of 85% by weight and 15% by weight of water. In the calculation of the M₂O or K₂O content, only the MOH or KOH is taken into account.

It has been found that, surprisingly, the alkaline medium of the binder in combination with the SiO₂ particles and the waterglass forms a particularly stable binder. It is assumed that μ-scale SiO₂ particles in particular, such as ground sand, function as reactive fillers, since the surface of the particles is partly dissolved in the alkaline medium and is superficially converted partly to alkali metal silicates. The filler character thereof is maintained, especially in a multimodal and/or broad size distribution, such that compaction and hardening results in the tightest packing of the partly dissolved particles. The hardening is assisted in particular by the raising of the SiO₂/M₂O modulus of the binder, especially to values above 8, especially above 9, and the additional input of SiO₂ via the particles. The good binding makes it possible to obtain composite materials, especially wood materials, having very good mechanical and water-resistant, or weathering-resistant, properties.

The precursor composition and the activated composition preferably do not contain any further crosslinking agents such as boric acid or refractory components such as aluminum salts. It is preferable that no other solvents apart from water are added. In addition, the precursor composition and the composition, apart from the gel former, do not comprise any polyols, such as glycol, glycerol or polyethylene glycol diglycidyl ether. Therefore, preferably no such organic crosslinkers are used for polysaccharide gel.

The activated composition preferably has an SiO₂/M₂O modulus of more than 8, especially of more than 9. Preference is given to an SiO₂/K₂O modulus of 8 to 16, preferably 9 to 14, very particularly 9 to 10.

The composition preferably does not comprise any further hydroxides, especially alkaline earth metal hydroxides such as Ca(OH)₂.

The composition preferably does not comprise any organosilanes or modified colloidal nanoparticles.

The activated composition may optionally contain up to 2% by weight, especially up to 1% by weight, of additives, which especially facilitate processing, for example thixotropic additives in the case of dilution, if the composition is to be sprayed. One example of such an additive is microfibrillated cellulose (MFC).

The activated composition is combined or contacted with biological carrier material, such as fibers, turnings or mats from biological sources. This can be accomplished by impregnation, soaking, coating, spray coating or other application methods. It is also possible to apply multiple plies of wood fibers and/or wood turnings, and activated compositions.

The biological carrier material is preferably obtained from a renewable raw material.

The biological carrier materials, such as fibers, turnings or mats from biological sources, can be obtained from any plants or woods that are suitable for composite materials.

The biological filler is preferably obtained from rice husks, rice glumes, reeds, sisal, hemp, cotton, kenaf, bamboo, flax, palms such as nipa or coconut, woods and/or sugarcane.

Examples of woods are conifers such as jaw, spruce, fir; linden, birch, pine, walnut, oak, acacia or the like.

Particular preference is given to local sources, which are also preferable with regard to CO₂ footprint.

The carrier material, especially wood, need not be dried.

The carrier material is preferably in the form of turnings or a mat.

The biological carrier material preferably has a proportion of SiO₂ of >1% by weight, especially >2% by weight, which assists the binding of the activated compositions to the carrier material. This is the case, for example, for acacia or rice straw which have a content of more than 5% by weight.

The wood fibers and/or wood turnings are preferably produced by chipping or hammer milling of solid wood or wood wastes from the sawmill industry. For the production of particleboards, the material is typically screened, with characterization of each screen fraction according to mesh size.

It is known to the person skilled in the art in the production of particleboards that the properties and appearance of the composite material can be influenced via choice of size distribution. It is also possible to apply various layers comprising fibers and/or turnings of different size, for example in order to obtain finer outer layers.

Preference is given to fibers and/or turnings, especially wood fibers and/or wood turnings, from at least one screen fraction having a range selected from a range between 0.5 mm and 10 mm. Preferably a screen fraction having a range from >1.4 mm to 4 mm. For finer layers, such as outer layers, it is possible, for example, to use the 1 mm to 2 mm, or 1 mm to 1.4 mm, screen fraction.

Combining preferably takes place in a corresponding mold corresponding to the shape of the composite material to be obtained.

The ratio between composition (binder) and the biological carrier material can be chosen in accordance with the composite material to be obtained. It is also possible within a composite to use different biological carrier materials, for example different screen fractions, in order to obtain a different surface structure, for example.

The ratio between solids in the composition and the biological carrier material can be chosen freely. It can be chosen depending on the material to be produced. It may also depend on the surface and/or density of the carrier material and/or of the SiO₂ particles. In the case of high density, less binder is required. It is also the case with a high surface area of the biological carrier material that more binder is required for wetting. Preference is given to using at least as much binder as is required for wetting of the surface of the biological carrier material.

The ratio may therefore be selected from a wide range. Preference is given to a ratio of mass of solids in the binder to carrier material by weight of 1:10 to 10:1, preferably 1:5 to 5:1, more preferably 20:80 to 80:16. As a result of the relation to mass, the ratios in principle correspond to the ratios of binder and carrier material in the composite material.

Preference is given to a weight ratio of 0.5:1 to 5:1.

Preference is given, for example, to a ratio of 1:1 to 4:1, especially 2.89:1 to 3.29:1, based on the mass of solids in the binder to the biological carrier material for compact boards.

Preference is given, for example, to a ratio of 0.3:1 to 1:1, especially 0.4:1 to 1:1, based on the mass of solids in the binder to the biological carrier material for lightweight construction boards.

Depending on the biological carrier material, it may be advantageous to leave the composite obtained to mature before compaction for up to 200 hours, preferably up to 180 hours, especially up to 150 hours. This can be done at rest or while stirring. In this way, the materials can bind better to one another.

The resultant composite is compacted in a mold under pressure and elevated temperature. It may be the mold in which the composite was combined in the preceding step.

Preference is given here to a temperature between 60 and 100° C., more preferably 80° C. to 90° C.

The composite is compressed until its strength is sufficient. This is the case, for example, after at least 4 hours, especially after 5 to 30 hours.

The necessary duration and temperature can be chosen for the respective application. A higher temperature generally also shortens the duration of compression.

The pressure used may be adjusted appropriately. The pressure is normally between 15 and 50 bar.

It may be advantageous to use activated mixtures that have been stored for at least 48 hours. The increased viscosity reduces the amount of binder expressed.

The composite obtained is demolded and dried to obtain the composite material, preferably under the action of a CO₂ source.

These are preferably conditions under which the composite material is carbonated. Incorporation of CO₂ results in further hardening of the composite material. Preference is given to carbonation within less than 240 hours, especially less than 120 hours, very particularly less than 48 hours.

These are typically conditions with an elevated CO₂ content compared to the atmosphere.

This can be effected, for example, by storing the samples in glycerol carbonate or propylene carbonate solutions. In an alkaline medium, these compounds release CO₂, which binds the excess hydroxide, for example KOH, in the composite material.

This can also be effected at elevated temperatures. Thereafter, the samples can be washed and dried.

Alternatively, the composite materials can also be stored in a climate-controlled chamber together with dry ice, for example 20° C. at 65% rel. humidity.

Carbonation is also possible by storage under natural atmosphere. Preference is given to storage for at least 30 days, preferably at least 50 days. Preference is given here to storage at ambient temperature, especially room temperature of 20 to 30° C.

Drying can be effected at elevated temperature, for example 60° C. to 100° C., especially 70° C. to 90° C.

It is also possible to provide the composite material with further layers, such as decorative layers, paint layers, varnishes.

The composite material of the invention obtained has many advantageous properties.

The waterglass-based binder used cures in a crack-free manner. The precursor composition has good storability before use. This simplifies handling and transport. The pot life of the activated composition can be controlled.

The CO₂ footprint is up to four times smaller than for cement.

In spite of the use of waterglass, high stability to weathering and hydrolysis is achieved.

The use of waterglass means that the composite material is intrinsically flame-retardant.

The composite material is suitable for the highest mechanical demands for wood materials, especially wood particleboards, in the construction sector (indoor and outdoor).

It also has exceptional resistance to termites.

Since it is possible to use local resources as wood source or source for the biological carrier material, the composite material is producible locally in a versatile manner. It is also possible to obtain the SiO₂ particles from local sand sources. In this way, it is possible in a simple manner to achieve local production of the wood materials.

The composite material is free of formaldehyde. Preference is also given to using no cement admixtures such as Ca(OH)₂.

In the course of drying, CO₂ is even absorbed.

The invention therefore also relates to a composite material produced by the process described above.

The composite material may have many kinds of shapes.

It is suitable, for example, for particleboards, furniture, doors, chairs, tables, interior fitout, worktops, cabinets, sideboards, floor panels, decking boards, wall elements, ceiling elements or roof elements.

The composite material preferably comprises wood fibers and/or wood turnings from acacia.

The invention also relates to a precursor composition obtained by step a) of the above process.

The invention also relates to the use of the precursor composition for production of a composite material.

Further details and features will be apparent from the description of preferred working examples that follows in conjunction with the dependent claims. It is possible here for the respective features to be implemented on their own, or several in combination with one another. The means of achieving the object are not limited to the working examples.

The working examples are shown in schematic form in the figures. Identical reference numerals in the individual figures denote elements that are the same or have the same function or correspond to one another in terms of their functions. The individual figures show:

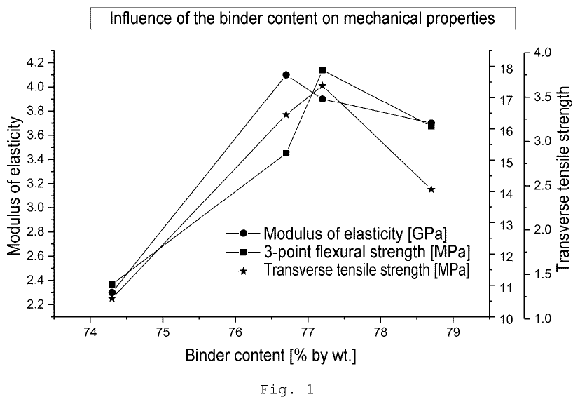

FIG. 1 dependence of the mechanical properties on the binder/fiber weight ratio;

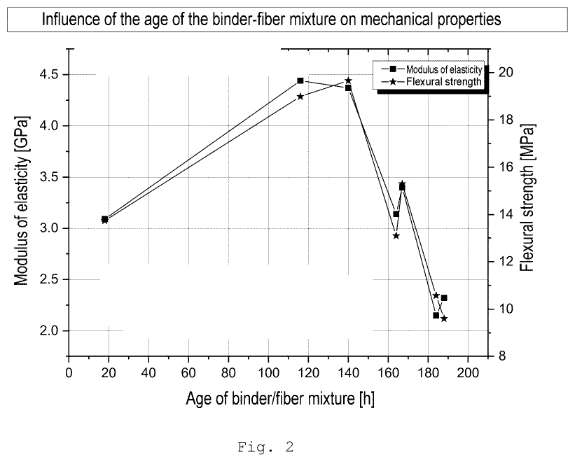

FIG. 2 dependence of the modulus of elasticity and the 3-point bending strength on the age of the binder/fiber mixture.

### PRODUCTION OF THE BINDER

### Example 1a: Precursor Composition (Precursor NMC4 210913)

13.15 g of potassium hydroxide (85% by weight) is dissolved while stirring in 161.73 g of van Baerle potassium waterglass (SiO₂/K₂O modulus: 2.93:1; density 1.42 g/ml, viscosity 40-50 mPas, about 41.3% by weight of solids). After the solution has been cooled down to room temperature, 2.63 g of guar (galactomannan with galactose/mannose ratio 1:2) is added thereto in small portions while stirring vigorously. On completion of addition of the guar, the solution has slightly elevated viscosity. For further swelling of the guar, the mixture is stirred at low speed at room temperature for at least a further 24 h. In this form, the binder precursor is indefinitely storable.

### Example 1b: Activation (NMC4 210913)

First 142.93 g of ground sand (size distribution: e.g. d(10)=0.547 μm; d(50)=3.793 μm; d(90)=19.642 μm and specific surface area about 4.01 m₂/g) is distributed homogeneously in 177.51 g of high-viscosity binder precursor with a dissolver disk. Thereafter, 7.6 g of fumed silica (primary particle distribution about 200-300 nm) is additionally stirred in homogeneously in small portions. The result is 328.04 g of a milky white binder paste (solids content: about 58.35%). The pot life of the activated binder is about 12 hours.

Size distribution is determined by laser diffraction. For this purpose, the Mastersizer 2000 from Malvern Panalytics was used. Particle size was determined by laser diffraction both for wet dispersion and for dry dispersion. For automated dry dispersion, a Scirocco 2000 unit was used. For wet dispersion, the automated Hydro 2000 S wet dispersing unit was used. While dry dispersion detected the fines down to about 200 nm, the wet method, by contrast, gave fines over and above 350 nm, but gave better reproducibility over 3 measurements/sample. The size distributions for the dry method gave values of 0.547 μm (d10), 3.793 μm (d50) and 19.642 μm (d90). Values ascertained by the wet method were 0.951 μm (d10), 3.722 (d50) and 19.982 (d90). Aqueous dispersion gives more homogeneous data, and dispersion of the sub-u-size particles gives a low result, apparently owing to agglomerate formation in the aqueous solution. The preferred values are based on wet methods.

Table 2 lists various binder compositions. Betol is a further waterglass. Wollner: Betol K57M: modulus about 1:1; density 1.65 g/ml of solids: about 52%; viscosity about 60 mPas. MFC is used as thixotropic additive on dilution. In the case of KOH, the weight is based on KOH with a KOH content of 85% by weight.

### Example 1c: Production of a Composite Board Based on Wood Turnings

328.04 g of binder paste (NMC4 210913) is mixed vigorously with 160 g of acacia turnings (>1.4 mm-<4 mm fraction). After about 30 minutes, the mixture is introduced homogeneously into a press mold provided with a nonstick coating. The press mold permits the production of a board of dimensions 20×20×1 cm³. The surface can additionally be upgraded by applying a binder-wood turning blend with a finer screen fraction of the chipped biomass. An illustrative composition is as follows: 72 g of activated binder paste is blended homogeneously with 24.4 g of a wood turning fraction of 1-1.4 mm and 12 g of a wood turning fraction of 500 μm to 1 mm, and applied homogeneously to a surface of the coarser wood turning-binder blend introduced into the press mold beforehand. In a hot press, the binder-wood turning blend is compressed and cured under reduced pressure at a temperature of 80° C. for 20 hours. The demolded boards are then dried to constant weight in a drying cabinet at 70 to 90° C. The ratio of binder solids to weight of acacia turnings is 1.2:1.

The carbonation is undertaken after the composite boards have attained constant weight:
a) in the climate-controlled cabinet at 20° C. and 65% rel. humidity for 3 days with sparging by CO₂ by means of dry ice. For this purpose, the dry ice is replenished after 8 h, 24 h, 32 h, 48 h, 56 h. For the 8-hour period, 5 g of dry ice is introduced, and for the 16-hour period correspondingly 10 g.
b) immersion into propylene carbonate (CO₂ source) and storage in a drying cabinet at 80° C. for 24 h. Thereafter, the composite boards are stored twice in demineralized water at room temperature for about 10 sec. Drying is effected at 80° C. in a drying cabinet overnight.
c) alternatively to propylene carbonate from example b), glycerol carbonate (CO₂ source) is used.

FIG. 1 shows the dependence of the mechanical properties on the binder/fiber weight ratio (binder here the solids of binder variant NMC4 210121, age of the precursor=1 d (=1 day old)). Thereafter, the precursor was activated with ground sand, and the acacia fibers were incorporated. After 2 hours, the shaping was conducted in a hot press at 80° C. and a pressure of 25 bar for 20 h. Demolding was followed by further curing in a drying cabinet at 80° C. for 24 h. Flexural strengths and transverse tensile strengths are ascertained after natural aging for 50-55 days.

### Example 2a: NMC4 210121

26.3 g of potassium hydroxide (85% by weight) is dissolved while stirring in 323.46 g of van Baerle potassium waterglass (SiO₂/K₂O modulus: 2.93:1; density 1.42 g/ml, viscosity 40-50 mPas, about 41.3% by weight of solids). After the solution has been cooled to room temperature, 5.26 g of guar (galactomannan with galactose/mannose ratio 1:2) is added thereto in small portions while stirring vigorously. On completion of addition of the guar, the solution shows slightly elevated viscosity. For further swelling of the guar, the mixture is stirred at low speed at room temperature for at least a further 24 h. The binder precursor is indefinitely storable in this form.

301.06 g of ground sand is stirred homogeneously into 355.02 g of high-viscosity binder precursor with a dissolver disk. The result is 656.08 g of a cream-colored binder paste (NMC4 210121) (solids content: about 58.35%).

### Example 2b:

140.6 g of acacia fibers is blended homogeneously with 656.08 g of binder (NMC4 210121). After being left to stand for 2hours, the resulting binder/fiber mixture is introduced into a press mold (cavity: 200×200×20 mm³) and compacted by means of a hot press at 80° C. and a pressure of 25 bar to a board of thickness 1 cm and precured under these conditions for 20 h.

The final curing is effected at 80° C. in a drying cabinet for 24 h.

### Example 3: Hemp Web Composite

98.2 g of potassium waterglass (van Baerle) is admixed with 8.6 g of KOH while stirring and cooling with an ice bath. Thereafter, 1.6 g of carboxymethylated guar (from Ranie Chemie Produktions-und Vertriebs-GmbH: RAGUM AD type) is added to the mixture in small portions. On completion of addition, the ice bath is removed and the mixture is stirred at room temperature overnight.

After about 20 h, 89.2 g of silica sol (Levasil 50/50) and then 36.6 g of ground sand are mixed into the precursor while stirring for activation. The result is 234.2 g of activated composition (based on NMC4) having an SiO₂/K₂O modulus of 12.31 and a solids content of about 46.4%. The binder is then worked manually into a hemp web (basis weight 1000 g/m²) having a weight of 21.6 g. An appropriate excess of binder is needed for homogeneous distribution of the binder in the hemp web having spongelike absorption. The binder prepared beforehand is used in full.

The binder-soaked web is then preconditioned in an oven preheated to 40° C. for 1 h. Thereafter, the web is precured in a hot press at 85° C. In the course of this, the excess binder is expressed. In order to achieve uniform evaporation of the residual water, the precured web is finally cured between perforated sheets in the hot press at 80° C. under reduced pressure for another 16 h.

The cured hemp composite weighs 92.65 g. This corresponds to a binder-hemp web ratio of 3.29 parts by weight of cured binder to one part by weight of hemp web.

### Example 4: Lightweight Construction Board

Spray application of the binder to the fibers and subsequent composite production:

238 g of fibers finely distributed in a tank and in a thin layer are wetted with the binder NMC4-MFC (table 2) with a spray gun (SATAjet) at a spray pressure of 1.0 bar. Once the fibers have been uniformly and finely wetted, the layer of fibers is turned by 180° and sprayed again until wetting with binder is clearly apparent.

The total weight of the wetted fibers is 442.6 g. 220.4 g is shut away in a separate vessel.

The remaining 222.22 g is finely distributed again in the tank and sprayed once more from both sides with binder. The wet weight thereafter is 276.8 g. This binder-fiber mixture too is shut away in a separate vessel until further processing.

For production of the composite boards, the two fiber-binder mixtures are each introduced into a baking paper-lined press mold (20×20×about 2 cm³) and compacted in a hot press to a layer thickness of 1 cm at a pressure of 30 bar and then precured at 85° C. After 1.5 h, the composite is demolded and subjected to further curing in a drying cabinet—inserted into a hardening frame at 80° C. for 40 h. The result is boards having a total weight of 169.29 g for sheet 1 and 204.59 g for sheet 2.

Carbonation was effected by storage under air and by absorption of CO₂ from the air.

The weight ratios of fibers to binder (cured) are as follows:
Sheet 1: about 2.33 fibers to 1 binder
Sheet 2: about 1.4 fibers to 1 binder

The sheets were examined by the following methods:

Bending tests: (EN 310, classification EN 312), modulus of elasticity, maximum tensile stress

Transverse tensile strength: (EN 319, classification EN 312)

Dry and after boil test EN 1087-1 (90 min 25° C.->100° C., 120 min @ 100° C.)

Water retention: (EN 317: thickness swelling, EN 321: moisture resistance via cycling test, EN 1087-1: boil test)

Depending on the test specimen, it was possible in the bending test to achieve a modulus of elasticity of 2.2 GPa (P2 classification according to EN 312) to 4.4 GPa (P7). The flexural strength was 11 MPa (P1) to 20 MPa (P6).

In the transverse tensile test according to EN 319, it was possible to achieve a strength of 1.2 MPa to 3.6 MPa (P7). Even after a boil test in water (90 min. 25° C.→100° C.; 120 min. 100° C.), a strength of 0.15 MPa to 0.35 MPa was still measured.

Samples were also stored at 20° C. in water for 24 hours. Sheets of the composite material of the invention with acacia turnings had only an increase in weight of 0% to 4% and an increase in thickness of 0% to 3%.

By virtue of the use of waterglass and SiO₂ particles, the composite material has good fire resistance. A glass foam is formed at high temperatures, which provides thermal insulation and prevents burning of the material. It was possible to subject a sheet produced to direct flame application at a temperature of above 1000° C. for 1 hour without ignition of or penetration through the board.

The resultant composite material, when stored in a field—within the movement radius of termites close to a termite nest—did not show any sign of termite infestation, even after 6 months.

FIG. 2 shows the dependence of the modulus of elasticity and the 3-point flexural strength on the age of the binder/fiber mixture. The binder precursor NMC4 having an age of 23 days was used for the production. After the binder/fiber mixture has aged for 5 to 6 days, a maximum is attained in flexural strength and modulus of elasticity (production parameters: pressed for 1.5 h at 40 bar and 80° C.; 75.1% by weight based on solids in the binder content, NMC4 as precursor).

Table 3 shows the dependence of the properties of the composites on the age of the storable binder precursors in days (d): 1 d, 4 d, 7 d, 15 d, 16 d, 21 d, 23 d. MFC means additization with microfibrillated cellulose.

The storage time of the composites produced was between 1.5 and 2 months at room temperature.

The test specimens were also subjected to accelerated carbonation according to at least one of the above variants.

After 2-3 months, the swelling tests were done, and then, after drying and conditioning to constant weight, the boil tests.

TABLE 1

| | | | Grain | Grain | Grain | Specific |
|---|---|---|---|---|---|---|
| | Chemical | | size | size | size | surface area |
| Admixture | composition | pH | d₁₀ | d₅₀ | d₉₀ | (BET) |
| Fumed aggregate | 99% SiO₂ | | | | | 200 ± 25 m²/g |
| 0.2-0.3 μm | (amorphous) | | | | | |
| Millisil W11 | 99% SiO₂ | 7 | | 22 μm | 55 μm | 0.8 m²/g |
| | (crystalline) | | | | | |
| Millisil W12 | 99% SiO₂ | 7 | | 16 μm | 50 μm | 0.9 m²/g |
| | (crystalline) | | | | | |
| Sikron SF 800 | 97.5% SiO₂ | 7 | | 2 μm | 6 μm | 6.0 m²/g |
| quartz | 2% Al₂O₃ | | | | | |
| | (crystalline) | | | | | |
| Treminex 958-006 | 60.8% SiO₂ | 9.5 | 4 μm | 32 μm | 140 μm | 0.8 m²/g |
| nepheline | 23.0% Al₂O₃ | | | | | |
| syenite | 10.4% Na₂O | | | | | |
| | 4.6% K₂O | | | | | |
| | (amorphous) | | | | | |
| Treminex 958-700 TST | 60.8% SiO₂ | 9.5 | 1 μm | 3 μm | 9 μm | 4.0 m²/g |
| nepheline syenite | 23.0% Al₂O₃ | | | | | |
| (trimethylsilane- | 10.4% Na₂O | | | | | |
| modified) | 4.6% K₂O | | | | | |
| | (amorphous) | | | | | |
| Tremin 939-010 | 50.0% SiO₂ | 9.5 | L₁₀ | L₅₀ | L₉₀ | 0.46 m²/g |
| wollastonite needles | 1% Al₂O₃ | | 22 μm | 77 μm | 207 μm | |
| Average aspect ratio: | 45% CaO | | | | | |
| L/D = 11/1 | 0.8% MgO | | | | | |
| Tremin VP939-302 | 50.0% SiO₂ | 9.5 | L₁₀ | L₅₀ | L₉₀ | 1.0 m²/g |
| wollastonite needles | 0.7% Al₂O₃ | | 13 μm | 46 μm | 110 μm | |
| Average aspect ratio: | 47% Cao | | | | | |
| L/D = 8/1 | 0.3% MgO | | | | | |
| | 1.0% Na₂O + K₂O | | | | | |

TABLE 2

| | Molar | | | | | | | | | |
|---|---|---|---|---|---|---|---|---|---|---|
| | SiO₂/K₂O | | | | Weight | | | | | |
| | modulus | Theor. | Theor. | | of | | | Weight | Alternative/ | |
| | after | SiO₂ | K₂O | Theor. | potassium | Weight | Weight | of | additional | Microfibrillated |
| | SiO₂ | content/g | content/g | H₂O | water- | of | of | ground | SiO₂ | cellulose |
| Mixture | addn. | (mol) | (mol) | content/g | glass/g | KOH/g | guar/g | sand/g | source/g | (MFC)/g |
| NMC4 | 12.31 | 4.75 | 0.61 | 6.27 | 4.91 | 0.43 | 0.08 | 1.83 | Levasil | 0 |
| basis | | (0.079194) | (0.006431) | | | | | | 50 nm/50 | |
| (comp.) | | | | | | | | | m²/g 4.46 | |
| NMC4 | 9.21 | 195.16 | 33.28 | 96.94 | 161.70 | 13.15 | 2.63 | 150.53 | 0 | 0 |
| 210121 | | (3.25271) | (0.35326) | | | | | | | |
| NMC4 | 9.23 | 201.26 | 34.22 | 107.46 | 161.70 + | 1.320 | 2.63 | 150.53 | 0 | 0 |
| 210701 | | (3.35432) | (0.36325) | | Betol 29.77 | | | | | |
| Betol | | | | | | | | | | |
| NMC4 | 9.21 | 429.79 | 73.28 | 400.76 | 356.10 | 28.96 | 5.79 | 331.50 | 0 | 5.79 |
| MFC | | (7.16318) | (0.77796) | | | | | | | |
| 210712 | | | | | | | | | | |
| NMC4 | 9.21 | 429.79 | 73.28 | 313.49 | 356.10 | 28.96 | 5.79 | 331.50 | 0 | 0 |
| 210712 | | (7.16318) | (0.77796) | | | | | | | |
| dil. | | | | | | | | | | |
| NMC4 | 9.21 | 1319.31 | 224.95 | 655.30 | 1093.06 | 88.90 | 17.78 | 966.22 | Silica fume | 0 |
| 210913 | | (21.98844) | (2.38801) | | | | | | 200-300 | |
| | | | | | | | | | nm 51.38 | |

TABLE 3

| | | | | | | Transverse | |
|---|---|---|---|---|---|---|---|
| | | | | | | tensile | |
| | Solids | Proportion | Modulus | | Transverse | strength after | |
| | content of | of wood | of | Flexural | tensile | boil test/MPa | Thickness |
| | binder/% | fibers/% | elasticity/GPa | strength/MPa | strength/MPa | (to EN 1087-1 | swelling |
| Mixture | by wt. | by wt. | (to EN 310) | (to EN 310) | (to EN 319) | and EN 319) | (to EN 317) |
| NMC4 1d | 76.7 | 23.3 | 4.1 | 15.22 | 3.3 | — | 5.18% |
| NMC4 4d | 77.2 | 22.8 | 3.9 | 17.88 | 3.63 | 0.35 | 2.18% |
| NMC4 7d | 78.7 | 21.3 | 3.7 | 16.08 | 2.46 | 0.30 | −1.44% |
| NMC4 15d | 74.4 | 25.6 | 3.0 | 12.61 | 0.96 | 0.17 | 1.55% |
| NMC4 16d | 74.3 | 25.7 | 2.3 | 11.03 | 1.23 | 0.39 | −5.73% |
| NMC4 21d | 75.0 | 25.0 | 2.9 | 12.34 | 1.11 | 0.13 | 1.47% |
| NMC4 23d | 75.1 | 24.9 | 3.09 | 13.74 | 1.69 | 0.19 | 2.14% |
| NMC4 MFC | 30.0 | 70.0 | | | 0.18 | | |
| NMC4 | 41.7 | 58.3 | | | 0.76 | | |
| diluted | | | | | | | |

1. A process for producing a composite material, comprising:
a) providing an alkaline composition comprising at least one alkali metal silicate waterglass, at least one organic gel former;
b) adding at least one type of SiO₂ particles;
c) combining the composition with at least one biological carrier material, such as fibers, turnings or mats from biological sources; and
d) compacting the resultant composite under pressure and elevated temperature in a mold;
e) after demolding, drying the composite to obtain the composite material.

2. The process as claimed in claim 1, wherein the organic gel former is a polysaccharide.

3. The process as claimed in claim 1, wherein the alkaline composition comprises at least one alkali metal hydroxide.

4. The process as claimed in claim 1, wherein the organic gel former is selected from comprises xanthan, gum arabic, guaran, galactomannans or mixtures thereof, where the gel former may have been chemically modified.

5. The process as claimed in claim 1, wherein the SiO₂ particles comprise ground sand.

6. A composite material obtained by the process as claimed in claim 1.

7. A precursor composition obtained from step a) of the process as claimed in claim 1.

8. (canceled)

9. A method of producing a composite material, comprising using the precursor composition as claimed in claim 7.
